(19) United States
(12) Patent Application Publication
(10) Pub. No.: US 2002/0120499 A1
(43) Pub. Date: Aug. 29, 2002

(54) System and method for membership vending

(76) Inventors: Te-Kai Liu, Mount Kisco, NY (US); Paul Andrew Moskowitz, Yorktown Heights, NY (US)

Correspondence Address: MCGINN & GIBB, PLLC, 8321 OLD COURTHOUSE ROAD, SUITE 200, VIENNA, VA, 22182-3817, US

(21) Appl. No.: 09/794,336

(22) Filed: Feb. 28, 2001

(51) Int. Cl. G06F 17/60

(52) U.S. Cl. 705/14

(57) ABSTRACT

A method (and system) of issuing a membership card to a user from a vending machine, includes selecting from information displayed on a vending machine according to an interest of the user, contacting entities selected by the user to set up the user's membership account, customizing a membership token with chosen membership privileges, and issuing the membership token to the user.

### BACKGROUND OF THE INVENTION

1. Field of the Invention

The present invention generally relates to a method and system for membership vending.

2. Description of the Related Art

Membership cards are commonly distributed at customer service desks of retail stores, hotels, restaurants, etc. The disadvantage of such a membership distribution process is that members are limited typically to local residents who already know where the stores are and the services/goods offered thereat. Consumers who are not familiar with the neighborhood or location that they are currently in (e.g., when traveling) often have to settle with whatever stores they can find first for shopping, dining, lodging, and other services). Merchants which are not located in well-known business districts will suffer the disadvantage incurred by their poor visibility.

### SUMMARY OF THE INVENTION

In view of the foregoing and other problems, drawbacks, and disadvantages of the conventional methods and structures, an object of the present invention is to provide a method and structure for membership vending.

In a first aspect of the present invention, a method of issuing a membership card to a user from a vending machine, includes selecting from information displayed on a vending machine contacting entities selected by the user to set up the user's membership account, customizing a membership token with chosen membership privileges, and issuing the membership token to the user.

In a second aspect of the invention, a method of issuing a membership token to a user from a vending machine, includes selecting from information displayed on the vending machine, contacting selected entities to set up the user's membership account, creating a membership token containing membership information, and transferring the membership token to the user's mobile device by a wireless connection.

In a third aspect, a system for a consumer to select a membership grade and obtaining a membership token, includes a display for allowing a user to select from information displayed on the display, the information including names of entities providing at least one of goods and services, a communication device for contacting entities selected by the user to set up a membership account for the user, a customizing unit for customizing a token with chosen membership privileges based on an information item selected by the user, and a token issuing unit for issuing the token to the user.

In a fourth aspect, a system for a consumer to customize the membership privileges and obtaining a membership token, includes means for selecting information displayed on a display according to an interest of the user, means for contacting entities selected by the user to set up the user's membership account, means for customizing a token with chosen membership privileges, and means for issuing the token to the user.

In a fifth aspect, a system for merchants to dynamically update their membership offerings available to consumers, includes means for selecting from information displayed on a display, means for contacting entities selected by the user to set up the user's membership account, means for customizing a token with chosen membership privileges, and means for issuing the token to the user.

In a sixth aspect, a system for a consumer to negotiate membership terms and obtain a membership token, means for selecting from information displayed on a display, means for contacting entities selected by the user to set up the user's membership account, means for customizing a token with chosen membership privileges, and means for issuing the token to the user.

In a seventh aspect, a method of issuing a membership token to a user interacting with a membership vending machine, displaying available membership grades to a user, and selecting a desired membership grade, displaying a cost and privileges associated with the selected membership grade, confirming by the user the membership grade selected, customizing a token for the user, issuing the customized token to the user, and notifying a membership vending server about the customized token having been issued.

In an eighth aspect, a method of verifying a membership token of a consumer, includes reading, at a point-of-sale terminal, membership information from a membership token, forwarding the membership information to a merchant membership server for verification, checking validity the membership token, replying to the point-of-sale terminal with the privileges to which the user is entitled, and displaying the verification result.

In a preferred embodiment, the membership token is a smartcard. However, other physical or electronic embodiments may be used. Also, in a preferred embodiment, the vending machine is a kiosk.

With the unique and unobvious aspects of the present invention, vending machines are deployed at strategic locations for accepting membership applications and distributing membership cards. Such locations include airports, seaports, public transportation stations, hotels, rest areas, shopping malls, retail establishments, restaurants, etc.

The membership vending machines provide information to users, help users to select the member privileges that they want, and customize and issue membership cards on the spot. A third party can manage the membership vending machines and broker the membership distribution process for various local merchants.

With sufficient storage capacity in membership cards such as smartcards, the membership cards can further contain addresses and phone numbers of the member stores, retail establishments, restaurants, hotels, etc. This information may be retrieved by in-car navigation systems and used to help consumers locate the local branches in a new area. With the combination of convenience and discount rates, the multi-merchant membership card is very appealing to travelers. Local merchants also enjoy higher revenues from travelers which they might otherwise not attract, and the party which manages the membership vending machines obtains the advertisement revenue from local merchants.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 illustrates the environment where the invention operates in;

FIG. 2 is a flowchart for the process of issuing a membership token to a user interacting with a membership vending machine;

FIG. 3 is a flowchart for the process of verifying a membership token;

FIG. 4 illustrates an exemplary hardware/information handling system 400 for incorporating the present invention therein; and

FIG. 5 illustrates a signal bearing medium 500 (e.g., storage medium) for storing steps of a program of the method according to the present invention.

### DETAILED DESCRIPTION OF PREFERRED EMBODIMENTS OF THE INVENTION

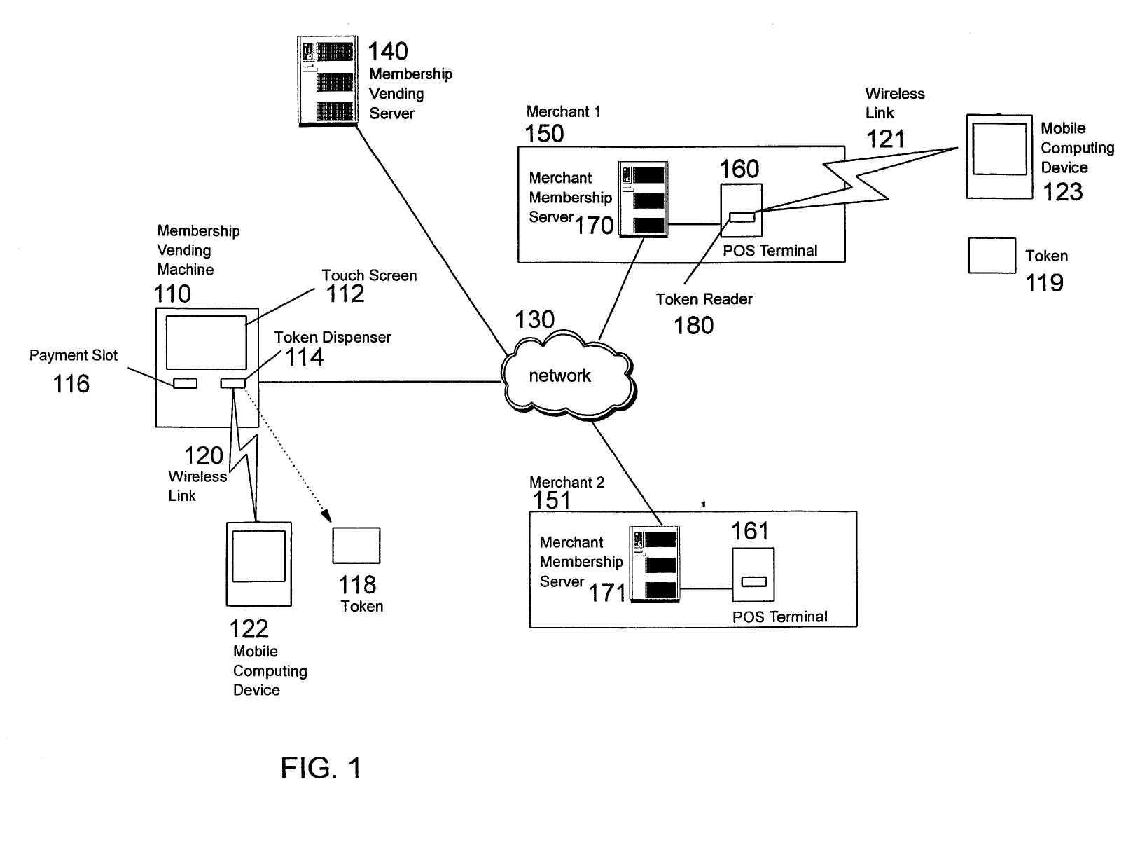

Referring now to the drawings, and more particularly to FIGS. 1-5, a detailed description will be given of the embodiments of the method and structures according to the present invention.

FIG. 1 illustrates a candidate environment in which the invention may operate.

As shown in FIG. 1, a membership vending machine 110 is preferably equipped with a touch screen display 112, a token dispenser 114, and a payment slot 116. The display 112 renders information and choices to users and obtains users' selection. The token dispenser or vending machine (e.g., kiosk) 114 issues a customized membership token 118 to a user.

The token 118 preferably is a smartcard in the preferred embodiment, although other formats may be used as well. These include a magnetic strip card, a diskette, a printed card which may include coded information in the form of a bar code, a radio frequency identification (RFID) tag such as the Mobile SpeedPass®. Alternatively, the token dispenser can issue an electronic copy of a membership token to a user's mobile computing device 122 through a wireless link 120 using, for example, the IEEE 802.11 standard, the Bluetooth technology (http://www.bluetooth.com) , a cellular phone wireless connection, infrared such as IrDA, etc. The membership may be for a retail buyers club, a restaurant discount club, airline frequent travel, hotel frequent guest, a cultural institution such as a museum, or even a credit card (for banking, gasoline purchases, telephone calling, etc.).

The payment slot 116 can accept bills or a credit card from consumers in case the issued membership token is not for free. The membership vending machine 110 can be implemented by modifying the program logic of the smartcard dispenser as disclosed, for example, in U.S. Pat. No. 6,129,275, incorporated herein by reference.

The membership vending machine 110 is further connected via network 130 to a membership vending server 140 which manages the audio/visual contents rendered to consumers and membership offerings that are currently available. The membership vending server 140 also detects the shortage of physical tokens stored in the membership vending machine 110, and notifies personnel at a time when replenishment is required. The network 130 can be implemented by any standard wired (and/or wireless) network technologies (e.g., local area networks, wide area networks, and cellular networks, or the Internet).

The membership vending server 140, via network 130, is further connected to the membership servers 170 and 171 of participating merchants 150 and 151, respectively. The membership servers 170 and 171 are notified of the identities (ID) and privileges of the new membership cards issued to consumers. When a consumer visits a participating merchant's store and wants to use his member privileges, the membership card 119 is read by the reader 180 of the point-of-sale (POS) terminal 160. Alternatively, the membership information is sent to the POS terminal 160 via a wireless link 121 from the consumer's mobile computing device 123.

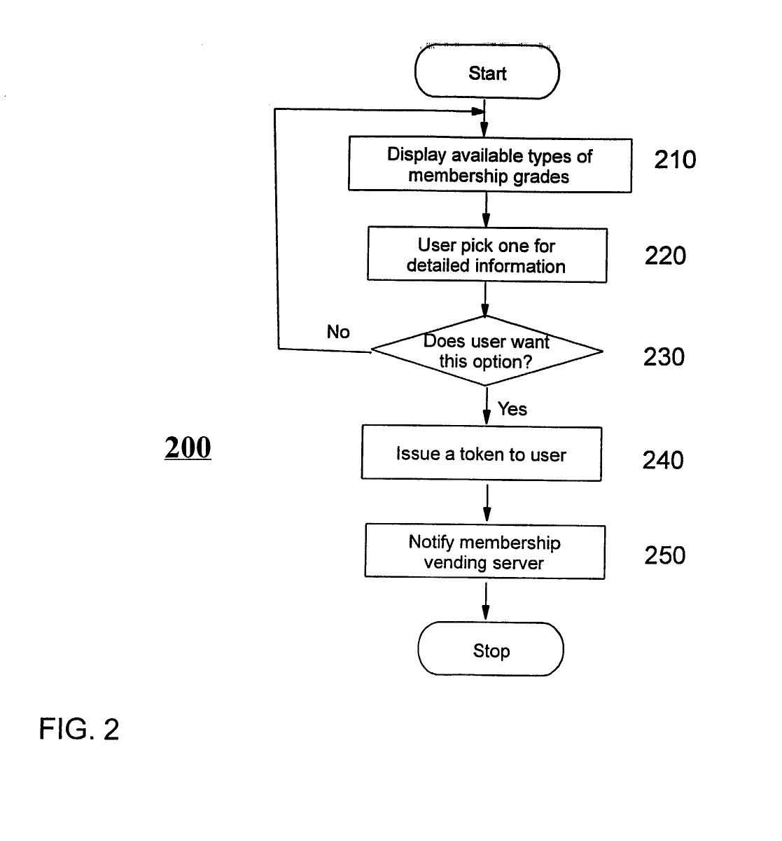

FIG. 2 is a flowchart for a process 200 of issuing a membership token to a user interacting with a membership vending machine.

Process 200 begins in step 210 by displaying available membership grades to the consumer (e.g., “low”, “intermediate”, “high”; “silver”, “gold”, “platinum” etc., or the like showing various levels of memberships). The consumer picks one that interests him most by, for example, touching the touch screen 112, and the vending machine displays the cost and the privileges given to the selected membership grade in step 220. Obviously, other input devices can be used besides the tough screen including any of a keyboard, joystick, mouse, trackball, etc.

If the consumer confirms this option by touching the “OK” (or “ENTER”, or another similar confirmation indicator) button on the screen in step 230, the vending machine customizes a card (or token) and issues the customized card (or token) to the consumer in step 240.

In step 250, the membership vending machine 110 responds by notifying the membership vending server 140 about the new card just issued in step 240.

Conversely, if the consumer does not accept the terms for this membership grade displayed in step 220 by touching a NO button (or similar button) on the screen in step 230, then the vending machine loops back to step 210 to display all available types of membership grades.

The various types of membership grades available to consumers can be used to attract different types of consumers. For example, some consumers may prefer to get a free membership card with minimum privileges. Other consumers may prefer to get more privileges at some affordable cost, while still others may want a deluxe membership which may cost more but the benefits and privileges (or status) are the highest. The privileges can be translated into shopping discounts, expedite checkout lines, better seatings/rooms, etc. Different membership grades can also be used to represent different periods during when the membership is effective (e.g., 1-day, 1-week, or 1-month membership, etc.). Such cards (and their underlying membership grades) would automatically expire at the end of the effective time period purchased by the consumer.

It is noted that in case the membership card itself does not hold all the privileges of the chosen membership grade, the membership vending server 140 must notify the involved merchants′ membership server 170 and 171 about the new card just issued and its privileges. This preferably occurs simultaneously with (or immediately after) the membership being purchased, so as to activate the cardholder's privileges and benefits.

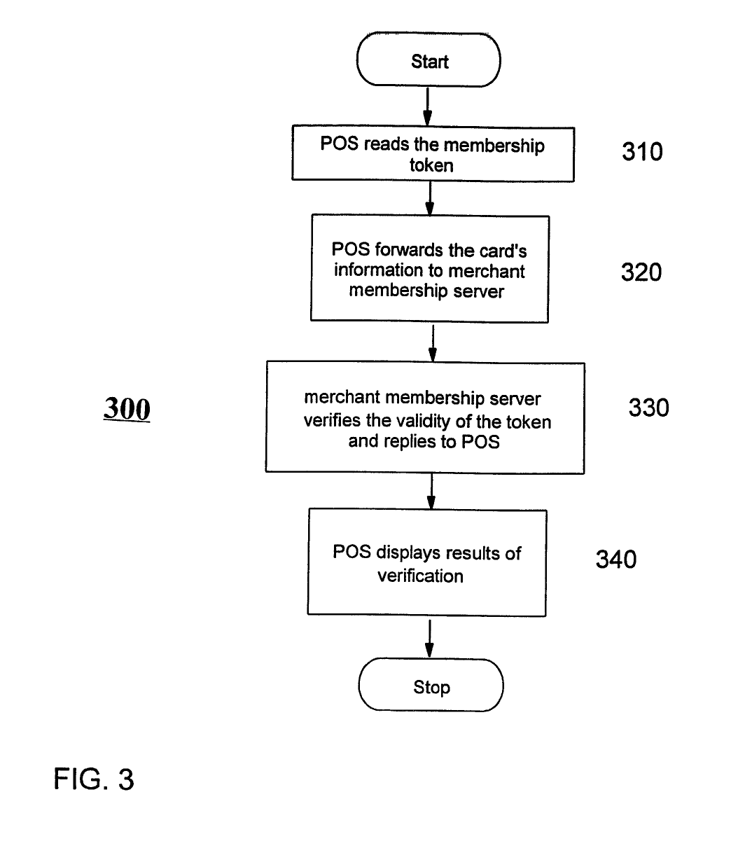

FIG. 3 is a flowchart for a process 300 of verifying a membership token (or card).

Process 300 begins with a POS terminal (e.g., terminal 160 in the exemplary embodiment of FIG. 1) reading a membership card (or token) inserted into the card reader 180 by a consumer in step 310. Then, the POS terminal forwards the card's information to the merchant membership server 170 for verification in step 320.

Then, in step 330, the merchant membership server 170 checks the validity and expiration date of the card, and replies to the POS terminal 160 with the privileges to which the card holder is entitled. The POS terminal 160 displays the verification result to the store's clerk and the consumer in step 340. In an alternative embodiment, the validity of the membership is verified locally. Step 330 is performed at the POS terminal (e.g., based upon a consistency check of the ID number, or a consistency check of a PIN (personal identification number) submitted by the customer). The PIN is a number that may be coded into the membership card or token at the time of issuance. The PIN is an example of a secret information known to the token user and an entity granting the membership. The entity may be a company such as a retail establishment, a health club, an airline frequent traveler club, a hotel frequent visitor club, a bank or other credit issuing establishment, an oil company (gas buying credit card), a phone company (calling card), a club, a nonprofit organization, or a branch of government (e.g., a government-run museum). An example of information not generally known might be the date of birth of the user.

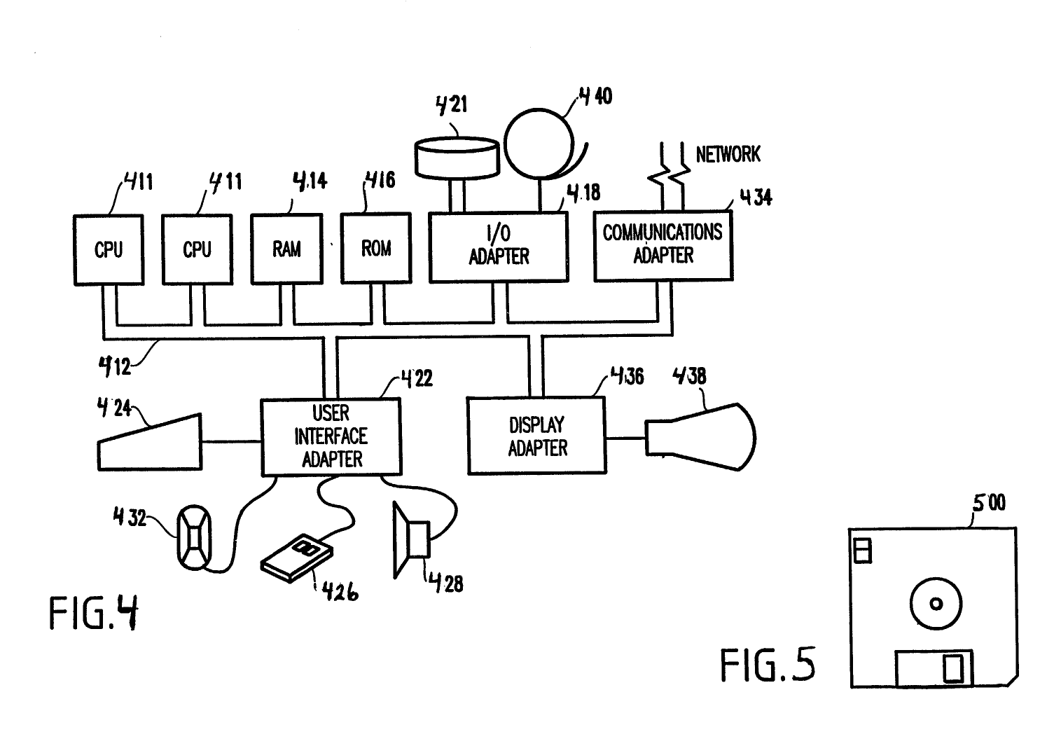

FIG. 4 illustrates a typical hardware configuration of an information handling/computer system in accordance with the invention and which preferably has at least one processor or central processing unit (CPU) 411. This configuration may be used to implement one or more of the servers 140, 170, and 171 (or mobile computing devices 122, 123) shown in FIG. 1

The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting an information handling system to a data processing network, the Internet, an Intranet, a personal area network (PAN), etc., and a display adapter 436 for connecting the bus 412 to a display device 438 and/or printer 439 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 411 and hardware above, to perform the method of the invention.

This signal-bearing media may include, for example, a RAM contained within the CPU 411, as represented by the fast-access storage for example. Alternatively, the instructions may be contained in another signal-bearing media, such as a magnetic data storage diskette 500 (FIG. 5), directly or indirectly accessible by the CPU 411.

Whether contained in the diskette 500, the computer/CPU 411, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

Thus, with the present invention, a system (and method) can be provided in which vending machines are deployed at strategic locations for accepting membership applications and distributing membership cards. The membership vending machines of the invention can provide information to users, help users to select the member privileges that they want, and customize and issue membership cards on the spot. A third party can manage the membership vending machines and broker the membership distribution process for various local merchants.

Preferably, the membership cards contain addresses, phone numbers, e-mail addresses, etc. of the member stores, retail establishments, restaurants, hotels, etc. Alternatively, this information may be retrieved by in-car navigation systems and used to help consumers locate the local branches in a new area.

Hence, such a system and method provide convenience and appealing privileges such as discount rates, etc., and local merchants can enjoy higher revenues from travelers which they might otherwise not attract. Moreover, the party managing the membership vending machines obtains advertisement revenue from local merchants.

While the invention has been described in terms of several preferred embodiments, those skilled in the art will recognize that the invention can be practiced with modification within the spirit and scope of the appended claims.

What is claimed is:

1. A method of issuing a membership token to a user from a vending machine, comprising:
selecting from information displayed on a vending machine;
contacting entities selected by the user to set up the user's membership account;
customizing a membership token with chosen membership privileges; and p1 issuing the membership token to the user.

2. The method of claim 1, wherein said selecting is performed by said user and said contacting is performed by said vending machine.

3. The method of claim 1, wherein said customizing is performed by said vending machine.

4. The method of claim 1, wherein said issuing is performed by said vending machine.

5. The method of claim 1, wherein said membership information comprises one of an account identification (ID), a secret information known to the token user and an entity granting the membership, a personal identification number (PIN), and dates of validity.

6. The method of claim 1, wherein said membership information comprises at least one of addresses, phone numbers and e-mail addresses, of establishments of said selected entities, which are located in a vicinity of said user.

7. The method of claim 1, wherein information displayed by the vending machine comprises advertisements and promotions of the entities offering membership at the vending machine.

8. The method of claim 1, wherein information displayed by the vending machine comprises specialties and discounts of entities offering membership at the vending machine.

9. The method of claim 1, wherein said contacting is performed by said vending machine and includes contacting said selected entities through a network comprising at least one of the Internet and a cellular network.

10. The method of claim 1, wherein the membership token comprises one of a smartcard, a magnetic strip card, a printed card, a radio frequency identification tag, and an electronic token.

11. The method of claim 1, wherein the membership is for one of a retail buyers club, a restaurant discount club, an airline frequent travel club, a hotel frequent guest club, a health club, a cultural institution, a banking credit card, a gasoline credit card, a telephone calling card, and a government-run institution.

12. The method of claim 1, wherein the vending machine is located at any of an airport, a seaport, a public transportation station, a hotel, a rest area, a shopping mall, a retail establishment, and a restaurant.

13. A method of issuing a membership token to a user from a vending machine, comprising:
selecting from information displayed on the vending machine;
contacting selected entities to set up the user's membership account;
creating a membership token containing membership information; and
transferring the membership token to the user's mobile device by a wireless connection.

14. The method of claim 13, wherein the wireless connection comprises at least one of Bluetooth, IEEE 802.11 Wireless local area network (LAN), and a cellular telephone.

15. The method of claim 13, wherein said selecting is performed by said user and said contacting is performed by said vending machine.

16. The method of claim 13, wherein said creating is performed by said vending machine.

17. The method of claim 13, wherein said transferring is performed by said vending machine.

18. The method of claim 13, wherein said membership information comprises one of an account identification (ID), a secret information known to the token user and an entity granting the membership, a personal identification number (PIN), and dates of validity.

19. The method of claim 13, wherein said membership information comprises addresses and contact numbers of establishments of said selected entity, which are located in a vicinity of said user.

20. The method of claim 13, wherein information displayed by the vending machine comprises advertisements and promotions of the entities offering membership at the vending machine.

21. The method of claim 13, wherein information displayed by the vending machine comprises specialties and discounts of entities offering membership at the vending machine.

22. The method of claim 13, wherein said contacting is performed by said vending 5 machine and includes contacting said selected entities through a network comprising at least one of the Internet and a cellular network.

23. A system for a consumer to select a membership grade and obtaining a membership token, said system comprising:
a display for allowing a user to select from information displayed on the display, said information including names of entities providing at least one of goods and services;
a communication device for contacting entities selected by the user to set up a membership account for the user;
a customizing unit for customizing a token with chosen membership privileges based on an information item selected by said user; and
a token issuing unit for issuing the token to the user.

24. A system for a consumer to customize the membership privileges and obtaining a membership token, said system comprising:
means for selecting information displayed on a display according to an interest of the user;
means for contacting entities selected by the user to set up the user's membership account;
means for customizing a token with chosen membership privileges; and
means for issuing the token to the user.

25. A system for merchants to dynamically update their membership offerings available to consumers, said system comprising:
means for selecting from information displayed on a display;
means for contacting entities selected by the user to set up the user's membership account;
means for customizing a token with chosen membership privileges; and
means for issuing the token to the user.

26. A system for a consumer to negotiate membership terms and obtain a membership token, said system comprising:
means for selecting from information displayed on a display;
means for contacting entities selected by the user to set up the user's membership account;
means for customizing a token with chosen membership privileges; and
means for issuing the token to the user.

27. A method of issuing a membership token to a user interacting with a membership vending machine, comprising:
displaying available membership grades to a user, and selecting a desired membership grade;
displaying a cost and privileges associated with the selected membership grade;
confirming by said user the membership grade selected;
customizing a token for the user, and issuing the customized token to the user; and
notifying a membership vending server about the customized token having been issued.

28. The method of claim 27, further comprising:
when the token includes not all the privileges of the chosen membership grade stored therein, notifying a merchant's membership server about the customized token just issued and its privileges.

29. A method of verifying a membership token of a consumer, comprising:
reading, at a point-of-sale terminal, membership information from a membership token;
forwarding the membership information to a merchant membership server for verification;
checking validity of the membership token, and replying to the point-of-sale terminal with the privileges to which the user is entitled; and
displaying the verification result.

30. A signal-bearing medium tangibly embodying a program of machine-readable instructions executable by a digital processing apparatus to perform a method of issuing a membership token to a user from a vending machine, comprising:
selecting from information displayed on a vending machine;
contacting entities selected by the user to set up the user's membership account;
customizing a membership token with chosen membership privileges; and
issuing the membership token to the user.
